(19) United States
(12) Patent Application Publication
(10) Pub. No.: US 2013/0204749 A1
(43) Pub. Date: Aug. 8, 2013

(54) SYSTEM AND METHOD OF ORGANIZATION OF INFORMATION

(71) Applicant: E-Commerce Media Grp BR. Participacoes Ltda, Sao Paulo (BR)

(72) Inventors: LENNON DE ALMEIDA MACHADO, Sao Paulo (BR); LEONARDO LOPES CARDOSO, Sao Paulo (BR); ROMERO VENANCIO RODRIGUES FILHO, Sao Paulo (BR)

(73) Assignee: E-COMMERCE MEDIA GROUP BRASIL PARTICIPACOES LTDA, Sao Paulo (BR)

(21) Appl. No.: 13/692,540

(22) Filed: Dec. 3, 2012

(30) Foreign Application Priority Data
Dec. 2, 2011 (BR) PI 1105352-6

(51) Int. Cl. G06Q 30/06

(52) U.S. Cl. CPC G06Q 30/0643
USPC 705/27.2

(57) ABSTRACT

A system and method capable of enabling the organization of information relating to products and/or services available on pages of virtual stores on the Internet may include at least a storage unit capable of storing information on the products and the virtual store, at least a human interface device capable of displaying the information on the products and the virtual stores, and at least a human control device capable of enabling an active interaction between a system user and the human interface device. The system may also include a processing unit operatively associated to the human interface device. The storage unit may include a virtual clipboard having at least one list of products.

### FIELD OF THE INVENTION

The present invention generally refers to a system and method of organizing information in electronic medium. More particularly, the present invention refers to a system and method capable of enabling the organization of information relating to products and/or services available on pages of virtual stores on the Internet.

### BACKGROUND OF THE INVENTION

Purchasing products and services over website pages of virtual stores on the Internet has become popular over recent years, as advantages such as convenience and savings have been provided to consumers. In this sense, it is important to note that most of these stores are able to deliver the products to people's homes or to any desired location. Furthermore, the prices of the products/services of the virtual stores are normally lower than those charged by physical stores, as the costs for maintaining a store virtual are significantly lower.

In parallel to this popularization of purchasing over the Internet, the offer of products/services for sale and the number of virtual stores has considerably increased, providing a wider gamut of purchase options for consumers.

Moreover, it is noted that consumers often get confused and lost amidst this large quantity of information available and, accordingly, ultimately give up purchasing over the Internet due to lack of time available and desire to search for the best prices and stores, or due to an incapacity to assimilate all the information.

In light of this, and with a view to facilitating the search for products over the Internet, search sites have been developed, along with sites for comparing prices, stores, products and services, which show as a search result, for example, a list of stores that sell a certain product and the price charged by each, among other relevant information. Thus the user was able to save sufficient time and effort in the process of purchasing products at the virtual stores on the Internet, because there was no longer a need to spend a lot of time navigating, searching, looking for and comparing the prices of the desired products at the various websites of these virtual stores. It is worth noting that said search and comparison sites are also known as virtual store aggregator websites or simply aggregator sites. To illustrate this, sites such as “Buscapé” (www.buscape.com.br), “Bondfaro” (www.bondfaro.com.br) and “Saveme” (www.saveme.com.br) are considered aggregator sites.

However, after noting and analyzing the behavior of users when accessing these aggregator sites, it was ascertained that many carry out more than one purchase per access, that is, they purchase several products in a single access. In this case, it was noted that a portion of the users tends to acquire all the products from a same store for convenience, even if the end price is not lower. Moreover, it was also confirmed that another portion of users always seeks the lowest prices and prefers to make multiple purchases in various stores to achieve this objective, even if this means longer navigation time.

Nevertheless, the process of organizing and comparing prices from search results is currently performed manually by the very user of the aggregator sites in situations where he wishes to make purchases of several products, which demands time and patience.

In light of the above, a technique is sought in which the results of searches for prices/stores on aggregator sites can be organized and presented so as to assist in the client's process of deciding to purchase.

### OBJECTIVES AND DESCRIPTION OF THE INVENTION

Therefore, an objective of the present invention is to provide a system and method of organizing information, for application on pages of price searches for products from virtual stores on the Internet, that are capable of filling the current gap in technologies known in the state of the art.

Furthermore, it is also an objective of the present invention to provide a system and a method capable of assisting users of search pages of prices of products from virtual stores on the Internet in the decision-making process of choosing the store(s) that best meets their expectations/criteria/requirements.

A further objective of the present invention is to provide a system and a method capable of providing users of search pages of prices of products from virtual stores on the Internet a new form of organizing information, so as to facilitate the decision-making process of choosing the store(s), in accordance with their expectations/criteria/requirements.

Moreover, another objective of the present invention is to provide a system and method capable of providing users of pages of price searches for products from virtual stores on the Internet with organized search results and presented in a manner to assist the decision-making process of purchasing in situations in which said users wish to acquire various products.

One or more objectives of the present invention mentioned above, among others, is(are) achieved through a system of organizing information on products available at virtual stores on the Internet. Said system comprises at least a storage unit capable of storing information on the products and the virtual stores. Furthermore, the system also comprises at least a human interface device capable of displaying the information on the products and the virtual stores. Additionally, the system comprises at least a human control device capable of enabling an active interaction between a system user and the human interface device. Moreover, the system comprises at least a processing unit operatively associated to the human interface device, to the human control device and to the storage unit. The storage unit comprises a virtual clipboard accessible by the user by means of the human interface device and the human control device, and the virtual clipboard comprises at least a list of products. The processing unit is arranged to enable the inclusion of at least one product in the list of products by means of the human interface device and the human control device. The processing unit is also arranged to list automatically the products included by the user in the list of products from virtual stores which provide said products.

According to additional or alternative embodiments of the system of the present invention, the following characteristics, alone or in combination, may also be comprised:

a processing unit is arranged to enable visualization and editing of the virtual clipboard and of the list of products by the user by means of the human interface device and the human control device;

a processing unit is arranged to enable the inclusion and the removal of products in and from the list of products by the user by means of the human interface device and the human control device;

the information stored in the storage unit on the virtual stores and the products consists of names of the stores, of the names of the products, of the prices charged by the virtual stores for each product, of the payment terms offered at each store, of the unit freight value and of the total value of the purchase per store;

a processing unit is arranged to arrange the information relating to the products contained in the list of products and to the virtual stores which provide said products in the form of a comparative table, a processing unit also being arranged to display the comparative table in the human interface medium;

the comparative table is endowed with a sequence of columns, and at least one column comprises the prices of the products;

the comparative table is endowed with a first column which comprises the names of the products;

the comparative table is endowed with a second column which comprises the names of the virtual stores and the respective prices of the products charged by these virtual stores, and the sum of the prices of the products of the second column is minimal, regardless of the number of stores;

the comparative table is endowed with a third column which comprises the prices of the products, and the sum of the prices of the products of the third column is minimal for a minimum number of stores;

the comparative table is endowed with a fourth column which comprises the names of the virtual stores and the respective prices of the products, and the sum of the prices of the products of the third column is minimal for a minimum number of stores plus one;

the comparative table is endowed with a fifth column which comprises the names of the virtual stores and the respective prices of the products, and the sum of the prices of the products of the fifth column is minimal for a minimum number of stores plus two;

the comparative table is endowed with a line of “totals” which comprises the sum of the prices of the products of each column; and

a virtual clipboard comprises a plurality of lists of products.

One or more objectives of the present invention mentioned above, among others, is(are) also achieved through a method of organizing information on products available at virtual stores on the Internet, which comprises the following steps:

i) preparing a list of products that a user wishes to acquire;

ii) searching for virtual stores which provide the products of the list prepared in step i;

iii) generating lists of prices of the products based on the virtual stores detected in step ii; and

iv) displaying to the user the lists of prices generated in step iii in the form of a comparative table endowed with a sequence of columns, and at least a column comprises the prices of the products.

According to additional or alternative embodiments of the method of the present invention, the following steps/substeps, alone or in combination, may also be comprised:

v) storing the list of products prepared in step i and/or the stores detected in step ii;

step iii comprises the following substeps:

iiia) calculating a total sum of the prices of the products of the list of products that is minimal, regardless of the number of stores;

iiib) calculating a total sum of the prices of the products of the list of products prepared in step i that is minimal, with a minimum number of stores;

iiic) checking whether the minimum number of stores relating to the substep iiib is less than the number of stores relating to the substep iiia;

iiid) should the verification of substep iiic prove positive, calculating a total sum of the prices of the products of the list of products that is minimal, with a minimum number of stores plus one;

iiie) checking whether the minimum number of stores plus one relating to the substep iiid is less than the number of stores relating to the substep iiia; and

iiif) should the verification of substep iiie prove positive, calculating a total sum of the prices of the products of the list of products that is minimal, with a minimum number of stores plus two;

step iv comprises the substep of iva) arranging a first column which comprises the names of the products of the list of products prepared in step i;

step iii comprises the substep of iiig) generating a first list of prices, and the total sum of the prices of the first list of prices is minimal, regardless of the number of stores;

step iv comprises the substep of ivb) arranging a second column which comprises the first list of prices and the sum of the prices of the first list of prices;

step iii comprises the substep of iiih) generating a second list of prices, and the sum of the prices of the second list of prices is minimal for a minimum number of stores;

step iv comprises the substep of ivc) arranging a third column which comprises a second list of prices and the sum of the prices of the second list of prices;

step iii comprises the substep of iiii) generating a third list of prices, and the sum of the prices of the third list of prices is minimal for a minimum number of stores plus one;

step iv comprises the substep of ivd) arranging a fourth column which comprises a third list of prices and the sum of the prices of the third list of prices;

step iii comprises the substep of iiij) generating a fourth list of prices, and the sum of the prices of the fourth list of prices is minimal for a minimum number of stores plus two;

step iv comprises the substep of ive) arranging a fifth column which comprises a fourth list of prices and the sum of the prices of the fourth list of prices;

if the number of stores of the second list of prices is different to one, step iv comprises the substep of ivf) informing the user in the third column that there is no single store tendering all the products of the list prepared in step i;

if the number of stores of the third list of prices is no greater than one, step iv comprises the substep of ivg) informing the user in the fourth column that no information is available for the third list of prices;

if the number of stores of the third list of prices is not less than the number of stores of the fourth list of prices, step iv comprises the substep of ivh) informing the user in the fifth column that no information is available for the fourth list of prices;

a step of vi) editing the products from the list of products prepared in step i;

step vi comprises the substep of via) removing at least one product from the list of products prepared in step i;

step vi comprises the substep of vib) adding at least one product from the list of products prepared in step i;

a step of vii) excluding the list of products prepared in step i; and

a step of viii) including a new list of products.

### BRIEF DESCRIPTION OF THE DRAWINGS

The objectives, technical effects and advantages of the system and method of organizing and displaying the information of the present invention shall be apparent to persons skilled in the art from the description of the following embodiment, which draws references to the accompanying drawings, illustrating an exemplary but not limitative embodiment of the present invention.

FIG. 1 shows a block diagram of a system of organizing information according to a particular embodiment of the present invention;

FIGS. 2 to 11 show flowcharts that illustrate a method of organizing information according to a particular embodiment of the present invention; and

FIGS. 12 to 17 show a sequence of screens that illustrate an example of application of the system and method of organizing information according to a particular embodiment of the present invention.

### DESCRIPTION OF AN EMBODIMENT OF THE INVENTION

At the outset, it is important to highlight that the system and method of organizing information, which are the objects of the present invention, shall now be described according to a particular but not limitative embodiment, since its implementations and embodiments may be carried out in different forms and variations and according to the application desired.

The system of organizing information of the present invention is particularly applied to price search pages of products available at virtual stores on the Internet (i.e., aggregator pages), online or offline. It is worth noting that the system may be used by Internet users by means of any device or suitable apparatus, such as, for example, notebook, tablet, television or smartphone. Thus, the system may be accessed from an Internet page or by a program application installed on any device. Further, the term “products” used herein refers both to objects as well as services.

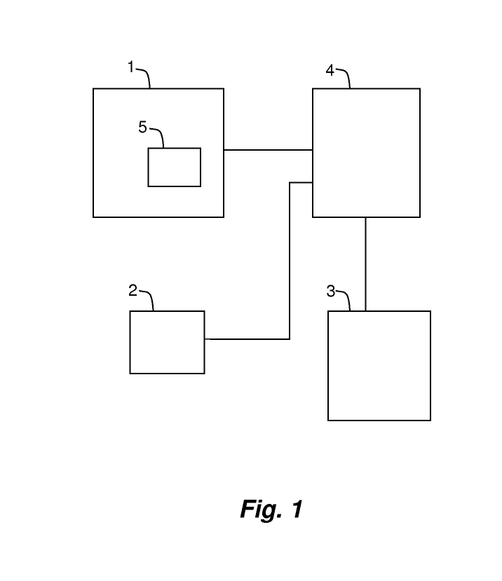

As can be seen in the block diagram in FIG. 1, said system comprises at least a storage unit 1 capable of storing information and data on the products and the virtual stores. The storage unit 1 consists of, for example, a non-volatile memory such as an EEPROM (Electrically Erasable Programmable Read Only Memory) chip or Flash-type memory. The information stored in the storage unit 1 on the stores and the products consist of, for example, the names of the stores, the names of the products, prices charged by the virtual stores for each product, the payment terms offered by each store, the unit freight value and the total value of the purchase per store. Naturally, other information and data can be stored in storage unit 1, such as the description of the virtual store and delivery time.

Furthermore, the system also comprises at least a human interface device 2 capable of displaying the information on the products and the virtual stores. The human interface device 2 consists of, for example, an LCD (Liquid Crystal Display) monitor or an LED (Light Emitting Diode). Optionally, other human interface means 2 may be used, provided that they allow systems users to view the information, such as holograph images.

Additionally, the system comprises at least a human control device 3 capable of enabling an active interaction between a system user and the human interface device 2. The human control device 3 consists of, for example, a mouse or computer keyboard. Alternatively, the human interface device 2 and the human control device 3 can be integrated in the form of a capacitive or resistive touchscreen.

Moreover, the system comprises at least a processing unit 4 operatively associated to the human interface medium 2, to the human control medium 3 and to the storage unit 1, as can be seen in FIG. 1. The processing unit 4 preferably consists of a programmable microcontroller or microprocessor. However, it is also possible to use electronic circuits endowed with analogical and/or digital electronic components arranged so as to execute the same functions as the programmable microcontroller or microprocessor.

Further pursuant to FIG. 1, the storage unit 1 comprises a virtual clipboard 5 accessible by the user by means of the human interface device 2 and the human control device 3. The virtual clipboard 5 comprises at least one list of products, preferably included and arranged by the user or, alternatively, suggested by the system itself.

Hence, the virtual clipboard 5 consists of a virtual file which contains at least one list of products which the user wishes to acquire, and each list of products consists of a subfile which has its own identification name (chosen by the user) such as, for example, “Christmas gifts” or “baby's bedroom”. The virtual clipboard 5 may comprise a plurality of lists of products. The list of products of a user may be kept locally or on a remote server.

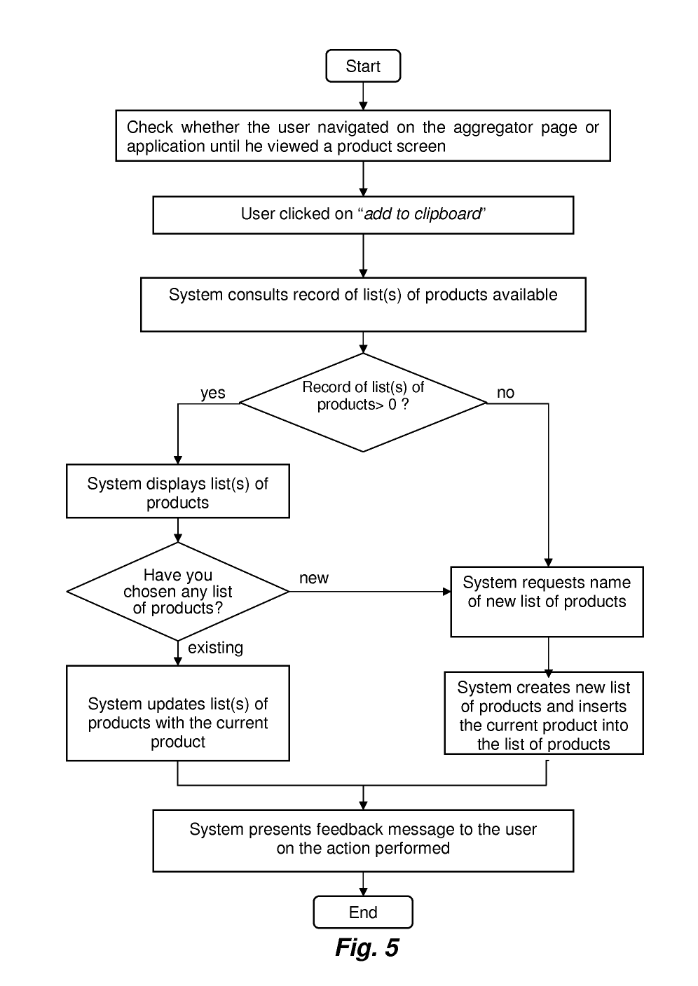

The processing unit 4 is arranged to enable the inclusion of at least one product in the list of products by means of the human interface device 2 and the human control device 3. Particularly, the inclusion of the list of products on the virtual clipboard 5 and the inclusion of the product in the list of products follows a registration flow, shown in FIG. 5, which preferably, but not compulsorily, comprises the following steps:

Checking whether the user navigated on the aggregator page or application up to viewing a product screen;

Checking whether the user clicked on “add to clipboard”;

Consulting a record of list(s) of products available on the virtual clipboard 5;

Displaying the record of list(s) of products, if there already exists at least one registered list of products. If not, request name for new list of products, create new list of products, insert the current product into the list of products and go to the last step (below);

Checking whether the user chose any existing list of products;

If so, update the list of products of the virtual clipboard 5 with the current product. If not, request name of new list of products, create new list of products and insert the current product into the list of products; and

Present feedback message to the user on the action performed.

The processing unit 4 is also arranged to enable visualization and editing of the virtual clipboard 5 and of the list of products by the user by means of the human interface device 2 and the human control device 3. Particularly, the processing unit 4 is arranged to enable the inclusion and removal of products in and from the list of products by the user by means of the human interface device 2 and the human control device 3. Moreover, it is also possible to include or remove lists of products in and from the virtual clipboard 5 and alter the name of the lists of products among other actions.

The processing unit 4 is further arranged to list automatically the products included by the user in the list of products on the virtual clipboard 5 from virtual stores which provide said products. Thus, the list of products consists not only of a record of products, but also assists the user on the decision to make the best buy from the various products in each list in the diverse stores.

More specifically, the processing unit 4 is arranged to arrange (organize) the information relating to the products contained in the list of products and the virtual stores which provide said products in the form of a comparative table.

Said comparative table is endowed with a sequence of columns, organized adjacently to each other, and at least one column comprises the prices of the products. Preferably, a plurality of columns comprise the prices of the products. A comparative table endowed with a first column comprises the names of the products. Additionally, the comparative table is endowed with a second column which comprises the names of the virtual stores and the respective prices of the products charged by these virtual stores, and the sum of the prices of the products of the second column is minimal, regardless of the number of stores. Furthermore, the comparative table is endowed with a third column which comprises the prices of the products, and the sum of the prices of the products of the third column is minimal for a minimum number of stores. Moreover, the comparative table is endowed with a fourth column which comprises the names of the virtual stores and the respective prices of the products, and the sum of the prices of the products of the third column is minimal for a minimum number of stores plus one. Moreover, the comparative table is endowed with a fifth column which comprises the names of the virtual stores and the respective prices of the products, and the sum of the prices of the products of the fifth column is minimal for a minimum number of stores plus two. It is important to note that the table may comprise a larger number of columns, depending, for example, on the quantity of stores and arrangement of the system. Put otherwise, although the comparative table of the particular embodiment described above presents five columns, it is possible to implement a comparative table with however many columns desired. Furthermore, the form of presentation of the comparative table may also vary to adjust to the comparison criteria used. Naturally, the number of lines of the comparative table varies with the quantity of products contained in the list of products.

The comparative table is further endowed with a line of “totals” which comprises the sum of the prices of the products of each column.

The comparative table is further endowed with a first line for the header to enable better understanding by the user on the information shown. Particularly, the header of the third column shows the store virtual where all the products were found, if such exists. The header of the fourth and fifth columns shows the quantity of virtual stores of the respective column, if such exists.

The processing unit 4 is further arranged to display the comparative table in the human interface medium 2.

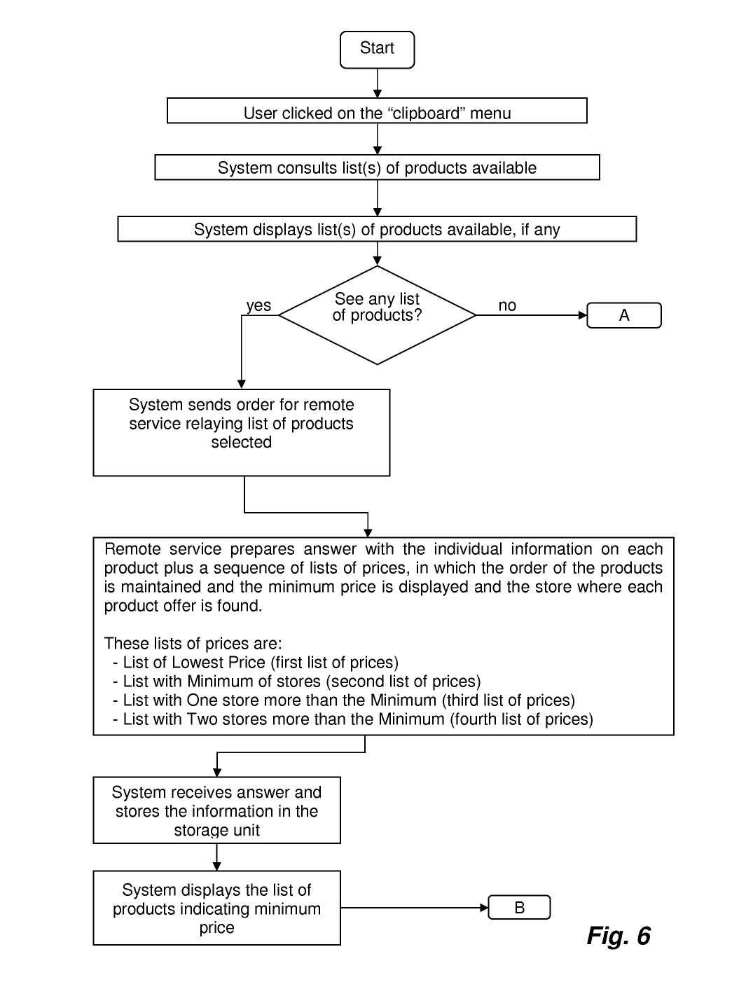

The formation of the comparative table follows the flow shown in FIG. 6, which preferably, but not compulsorily, comprises the following steps:

Checking whether the user clicked on the “clipboard” menu;

Consulting list(s) of products available;

Displaying the record of list(s) of products available, if any;

Sending an order to remote service (or locally) relaying the list of products selected, if the user has decided to visualize any list of products;

Drawing up a reply with the individual information on each product and another sequence of lists of prices, in which the order of the products is maintained, displaying the minimum price and the store where each product offer was found. These lists of prices are: List of Lowest Price (first list of prices); List with Minimum of Stores (second list of prices); List with One more Store than the Minimum (third list of prices); and List with Two more Stores than the Minimum (fourth list of prices);

Receiving a reply and saving the information in the storage unit 1; and

Displaying the list of products indicating minimum price.

The lists of prices mentioned above are described as follows:
List of Lowest Price (first list of prices): shows the stores with lowest price of each product and the total sum of these prices, regardless of the quantity of stores involved;
List with Minimum of Stores (second list of prices): shows the combination, with lowest number of different stores, and particularly with just one store, with the lowest price from among these combinations, so as to purchase the entire list of products at one store only;
List with One Store more than the Minimum (third list of prices): shows the combination, with the lowest number of different stores plus one, and with the lowest price among these combinations, so as to purchase the entire list of products; and
List with Two Stores more than the Minimum (fourth list of prices): shows the combination, with the lowest number of different stores plus two, and with the lowest price from among these combinations, so as to purchase the entire list of products.

It is important to spotlight that the quantity of lists of prices returned may be extended to any quantity among the minimum of stores and the quantity of products in the list of products.

All the lists of prices also inform the total value corresponding to the total sum of the prices of each product and the total quantity of stores used in the list. Additionally, other information may also be shown, such as freight, delivery time, among others.

Furthermore, the comparison criteria for determining the lists of prices may also vary so as to consider other criteria, such as: distance to be covered, journey time, stock availability, store certification/invoice, etc. Moreover, other entry parameters may also be required besides the names of the product to enable use of these varied comparison criteria.

Accordingly, the comparative table of the present invention provides users with organized search results, presented in a way to assist the decision-making process on purchasing in situations where said users wish to acquire several products.

Hence, the comparative table of the present invention assists users of search pages on prices of products from virtual stores in the decision-making process of choosing the store(s) that best meets their expectations.

In other words, the comparative table of the present invention provides users with a new form of organizing information that facilitates and simplifies the decision-making process of choosing the store(s), commensurate with their criteria and requirements.

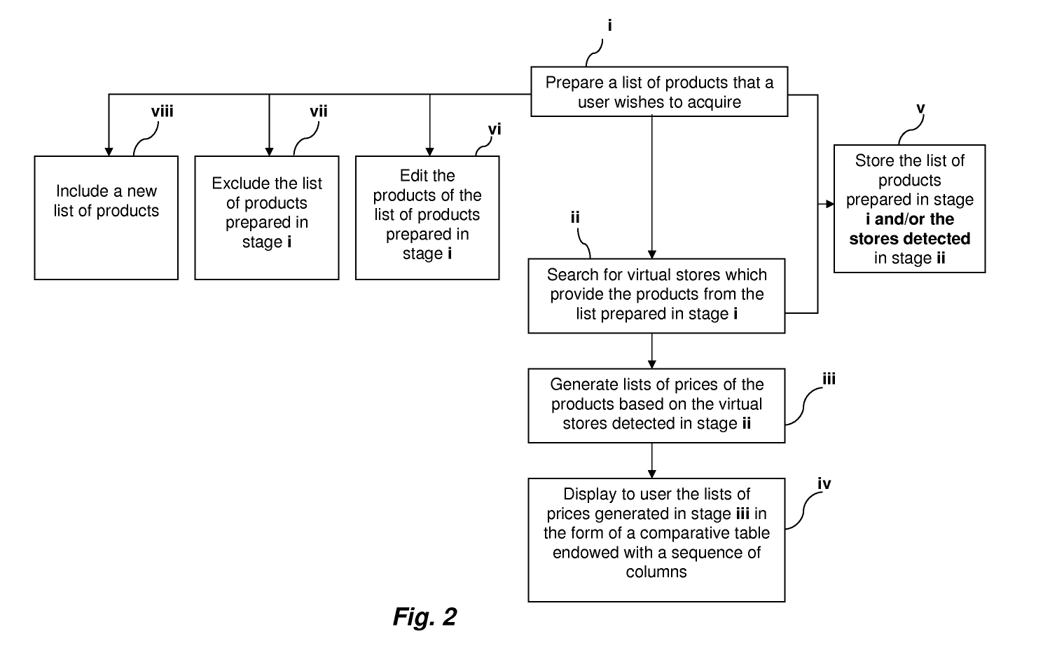

The advantages described above are also achieved by a method of organizing information according to the present invention. As can be seen in FIG. 2, said method comprises the following steps:

i) preparing a list of products that a user wishes to acquire;

ii) searching for virtual stores which provide the products of the list prepared in step i;

iii) generating lists of prices of the products based on the virtual stores detected in step ii; and

iv) displaying to the user the lists of prices generated in step iii in the form of a comparative table endowed with a sequence of columns, and at least one column comprises the prices of the products. Particularly, further pursuant to FIG. 2, the method of the invention may further comprise one or more of the following steps:

v) storing the list of products prepared in step i and/or the stores detected in step ii;

vi) editing the products from the list of products prepared in step i;

vii) excluding the list of products prepared in step i; and

viii) including a new list of products. The inclusion of the list of products follows the registration flow already described in this specification (FIG. 5).

Step vi mentioned above includes the substep of:

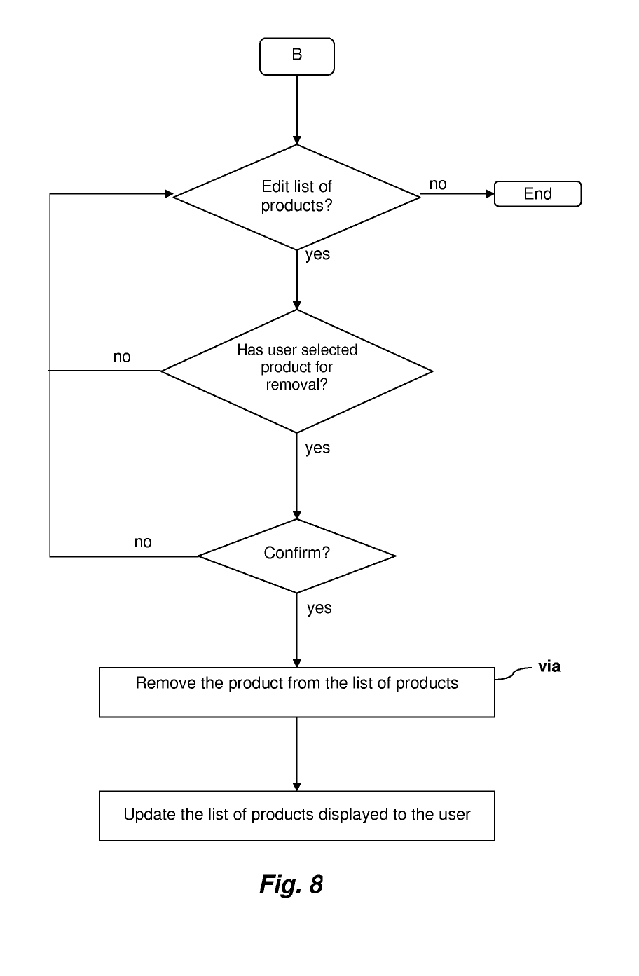

via) removing at least one product from the list of products prepared in step i. More specifically, the flow of removal of the product comprises the following steps, as can be seen in FIG. 8.

Checking whether the user wishes to edit a list of products;

Checking whether the user selected a product for removal;

Checking user confirmation;

Removing the product from the list of products; and

Updating the list of products displayed to the user.

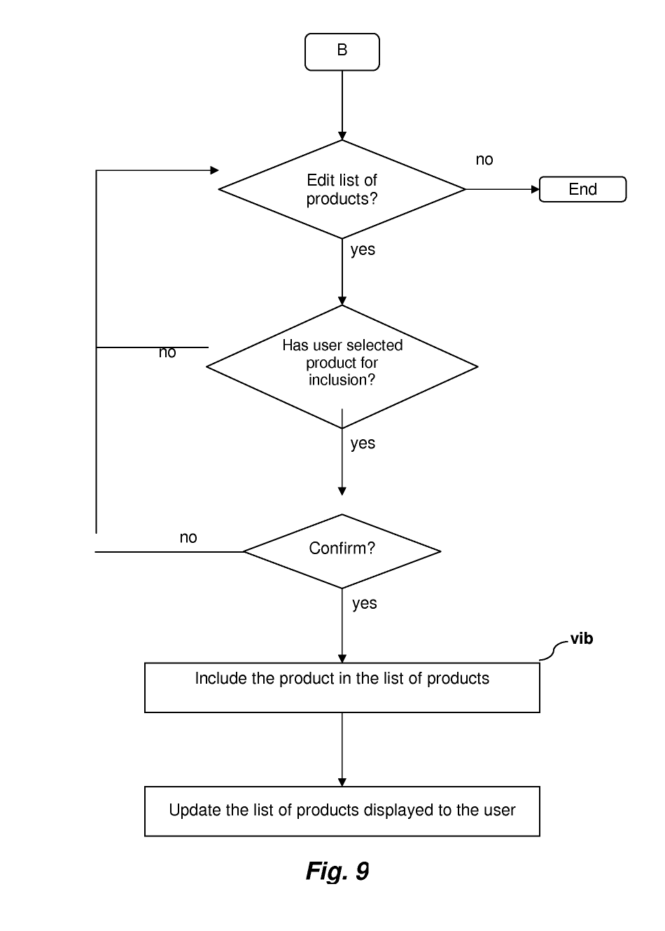

Step vi mentioned above also includes a substep of vib) adding at least one product from the list of products prepared in step i. More specifically, the flow of addition (inclusion) of a product comprises the following steps, as can be seen in FIG. 9.

Checking whether the user wishes to edit a list of products;

Checking whether the user selected a product for inclusion;

Checking user confirmation;

Including (adding) the product into the list of products; and

Updating the list of products displayed to the user.

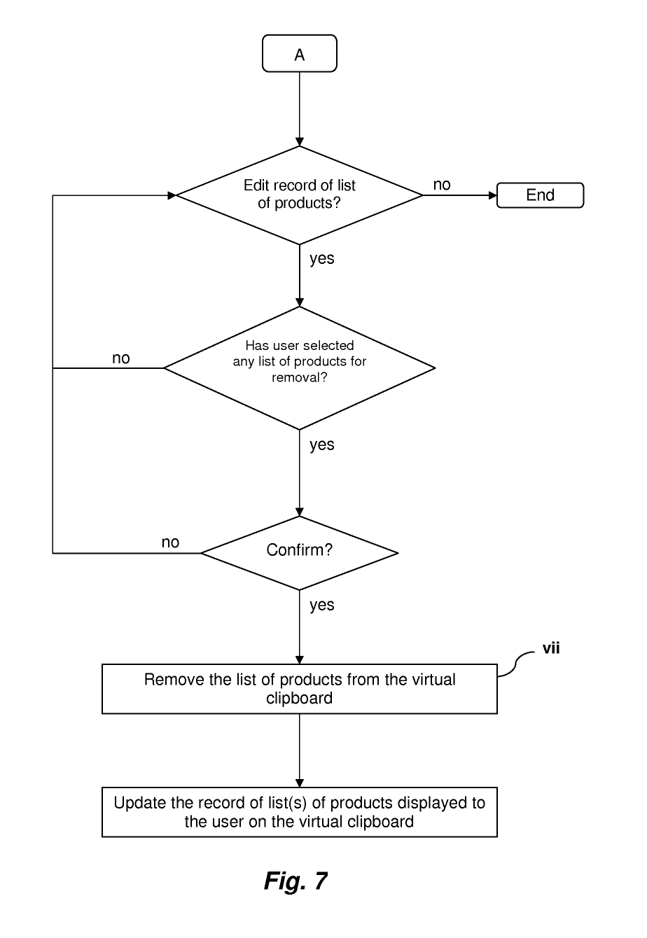

Step vii mentioned above follows a flow of removal, shown in FIG. 7, which preferably, but not compulsorily, comprises the following steps:

Checking whether the user wishes to edit the record of list(s) of products (to edit the virtual clipboard 5);

Checking whether the user selected any list of products for removal from virtual clipboard 5;

Checking user confirmation;

Removing the list of products from the virtual clipboard 5; and

Updating the record of list(s) of products displayed to the user on the virtual clipboard 5.

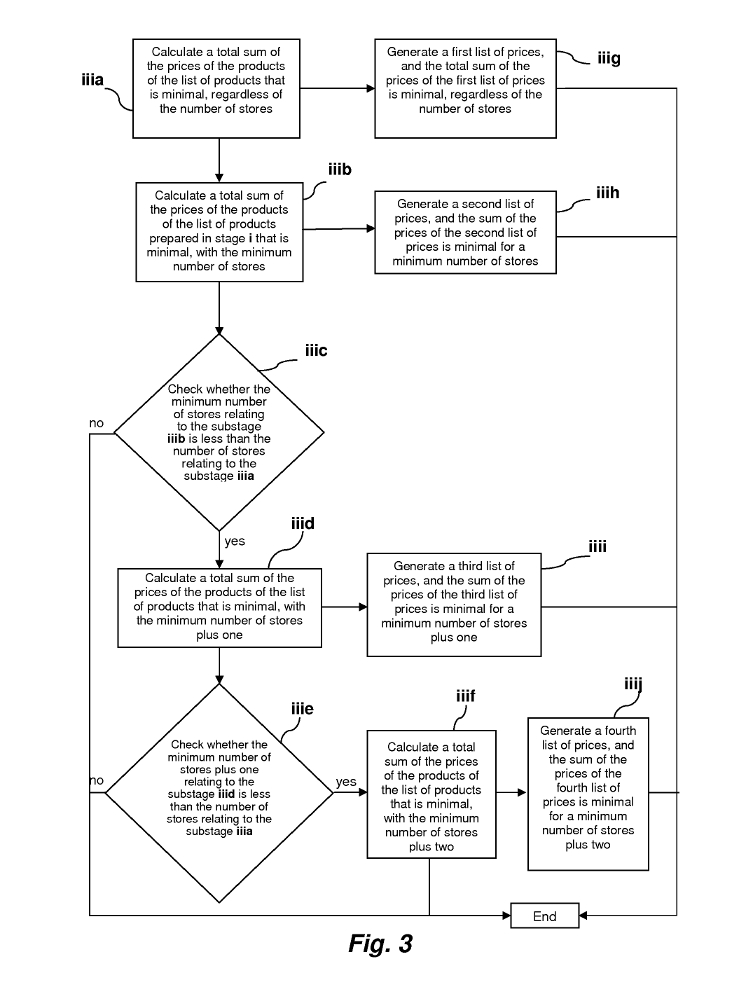

Particularly, and pursuant to FIG. 3, step iii above comprises the following substeps:

iiia) calculating a total sum of the prices of the products of the list of products that is minimal, regardless of the number of stores;

iiib) calculating a total sum of the prices of the products of the list of products prepared in step i that is minimal, with a minimum number of stores;

iiic) checking whether the minimum number of stores relating to the substep iiib is less than the number of stores relating to the substep iiia;

iiid) should the verification of substep iiic prove positive, calculating a total sum of the prices of the products of the list of products that is minimal, with a minimum number of stores plus one;

iiie) checking whether the minimum number of stores plus one relating to the substep iiid is less than the number of stores relating to the substep iiia; and

iiif) should the verification of substep iiie prove positive, calculating a total sum of the prices of the products of the list of products that is minimal, with a minimum number of stores plus two.

Further pursuant to FIG. 3, step iii comprises the substeps:

iiig) generating a first list of prices, and the total sum of the prices of the first list of prices is minimal, regardless of the number of stores;

iiih) generating a second list of prices, and the sum of the prices of the second list of prices is minimal for a minimum number of stores;

iiii) generating a third list of prices, and the sum of the prices of the third list of prices is minimal for a minimum number of stores plus one; and

iiij) generating a fourth list of prices, and the sum of the prices of the fourth list of prices is minimal for a minimum number of stores plus two.

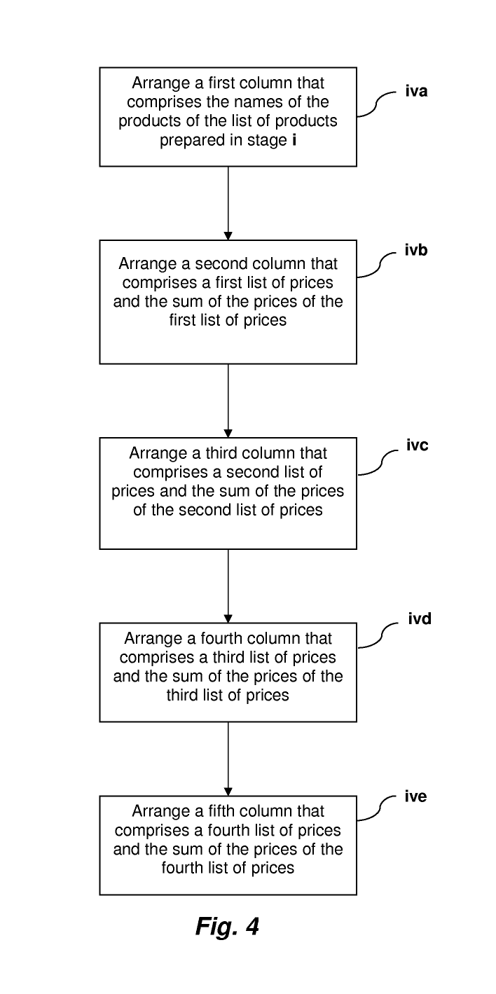

Particularly, and pursuant to FIG. 4, step iv above comprises the following substeps:

iva) arranging a first column which comprises the names of the products of the list of products prepared in step i.

ivb) arranging a second column which comprises the first list of prices generated in substep iiig and the sum of the prices of the first list of prices.

ivc) arranging a third column which comprises a second list of prices generated in substep iiih and the sum of the prices of the second list of prices.

ivd) arranging a fourth column which comprises a third list of prices generated in substep iiii and the sum of the prices of the third list of prices.

ive) arranging a fifth column which comprises a fourth list of prices generated in substep iiij and the sum of the prices of the fourth list of prices.

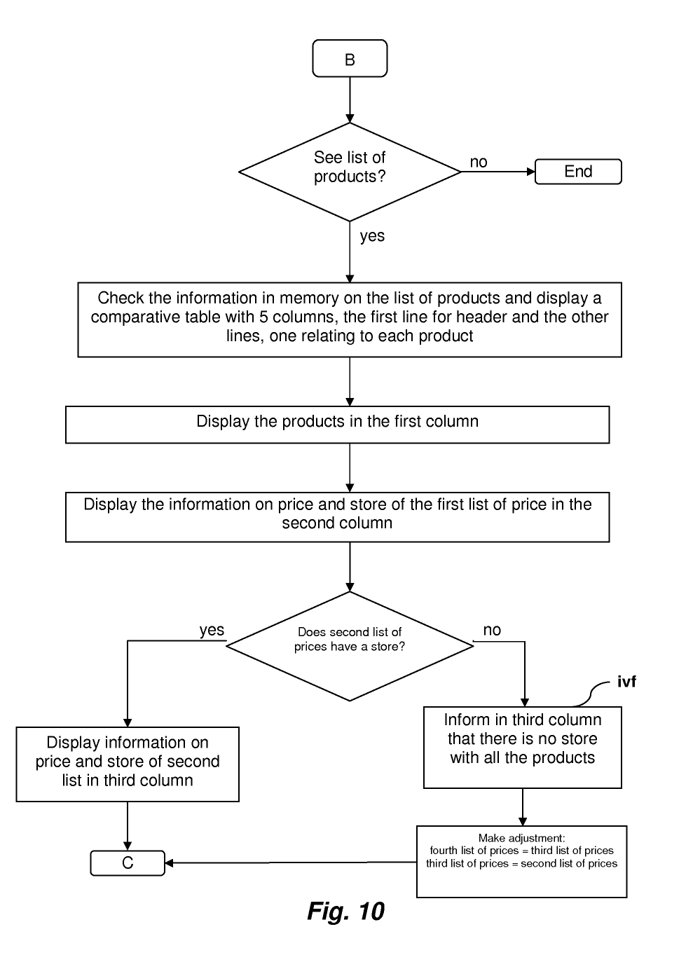

It must be emphasized that pursuant to FIG. 10, if the number of stores of the second list of prices is different to one, step iv comprises the substep of ivf) informing the user in the third column that there is no single store tendering all the products of the list prepared in step i. In this case, the method is suitable wherein: fourth list=third list; and third list=second list. If the number of stores of the second list is equal to one, the information on price and store of the second list of prices is shown in the third column.

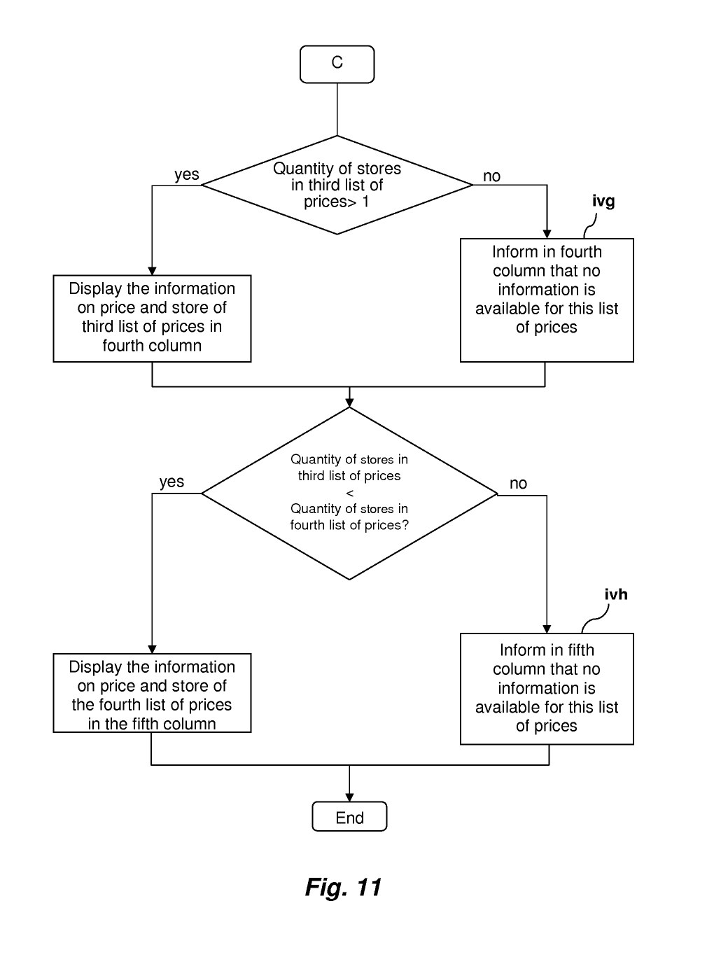

Furthermore, pursuant to FIG. 11, if the number of stores of the third list of prices is no greater than one, step iv comprises the substep of ivg) informing the user in the fourth column that no information is available for the third list of prices. Otherwise, the information on price and store of the third list of prices is displayed in the fourth column.

Further pursuant to FIG. 11, if the number of stores of the third list of prices is not less than the number of stores of the fourth list of prices, step iv comprises the substep of ivh) informing the user in the fifth column that no information is available for the fourth list of prices. Otherwise, the information on price and store of the fourth list of prices is displayed in the fifth column.

### EXAMPLE

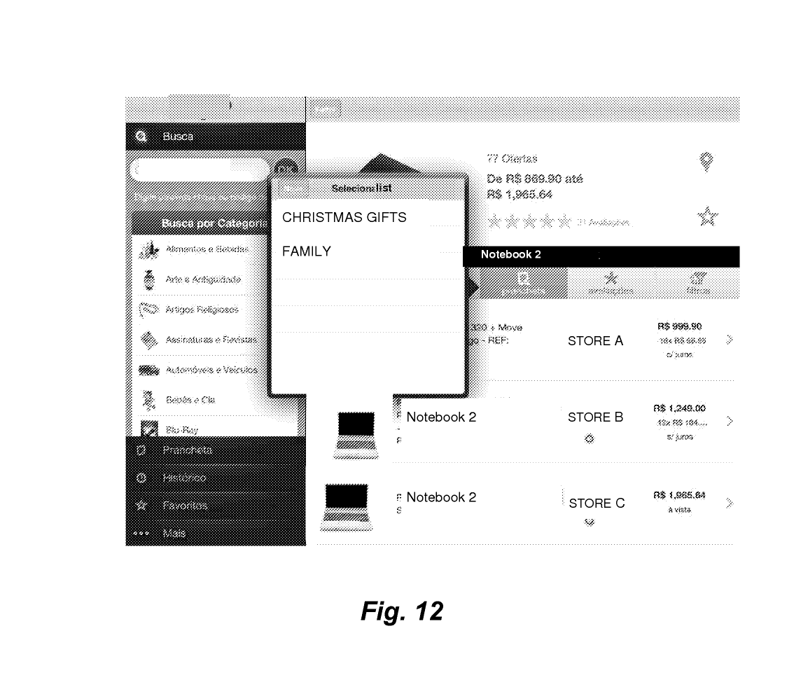

FIGS. 12 to 17 show a sequence of screens that illustrate an example of implementation and application of the system and method of the present invention. Said screens are displayed on the human interface device 2.

Initially, the user should access the Internet page application for searching for products from virtual stores (i.e., aggregator pages or applications) to find a certain product on which he wishes to know the best prices and virtual stores for purchasing. Said page or application presents a screen with details on the product and virtual stores found which provide said product. In this example, the user searched for the product “Notebook 2”, which was found at stores “Store A”, “Store B” and “Store C”, as can be seen in FIG. 12.

As further seen in FIG. 12, this screen of details of the product and virtual stores has a button named “Clipboard” which allows the inclusion of a current product into a list of products that already exists or into a new list of products to be created. Accordingly, the user clicks on the button “Clipboard” and chooses a list of products or creates a new one, ascribing a desired name. In this example, there are already two lists of products created on the clipboard, namely, “Christmas Gifts” and “Family”, in which the user selected the list

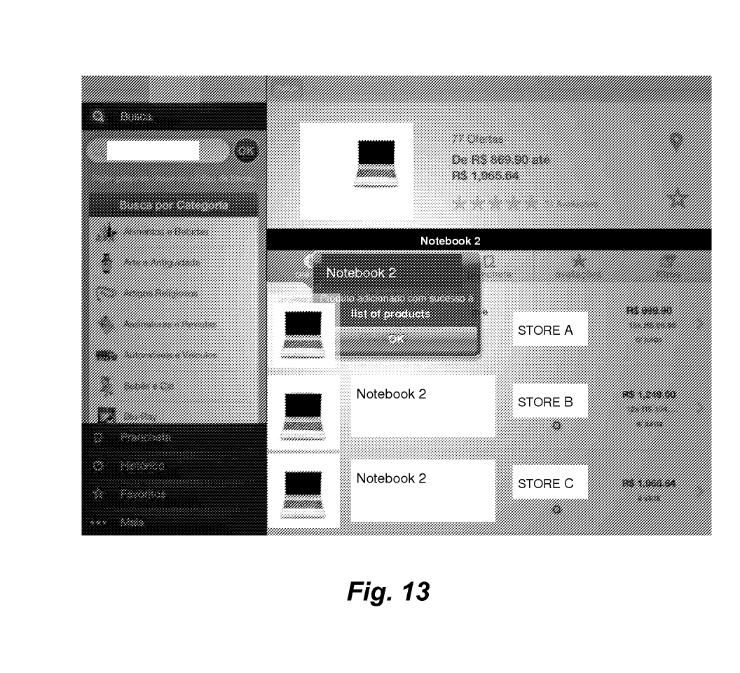

“Christmas Gifts” to include the product “Notebook 2”. FIG. 13 shows a notice informing the user that product “Notebook 2” was successfully included. Afterwards, the data from the list of products is updated (the lists of products are kept on a database, locally or remotely).

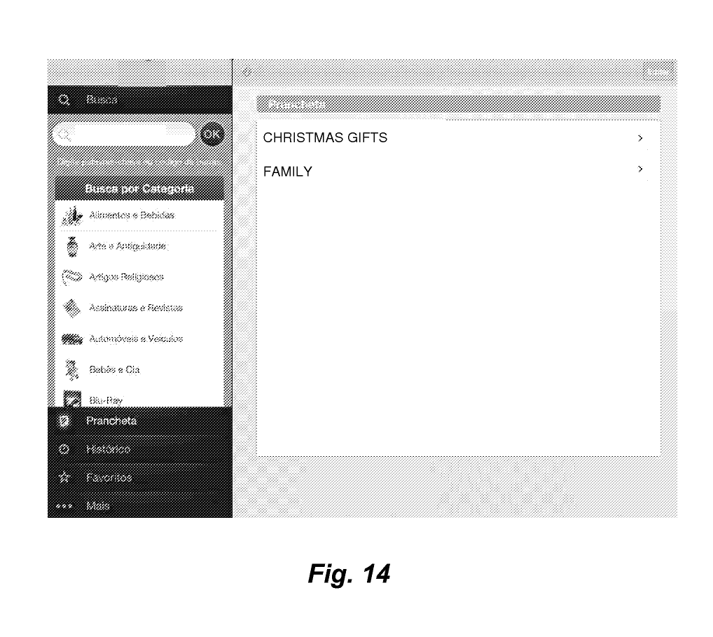

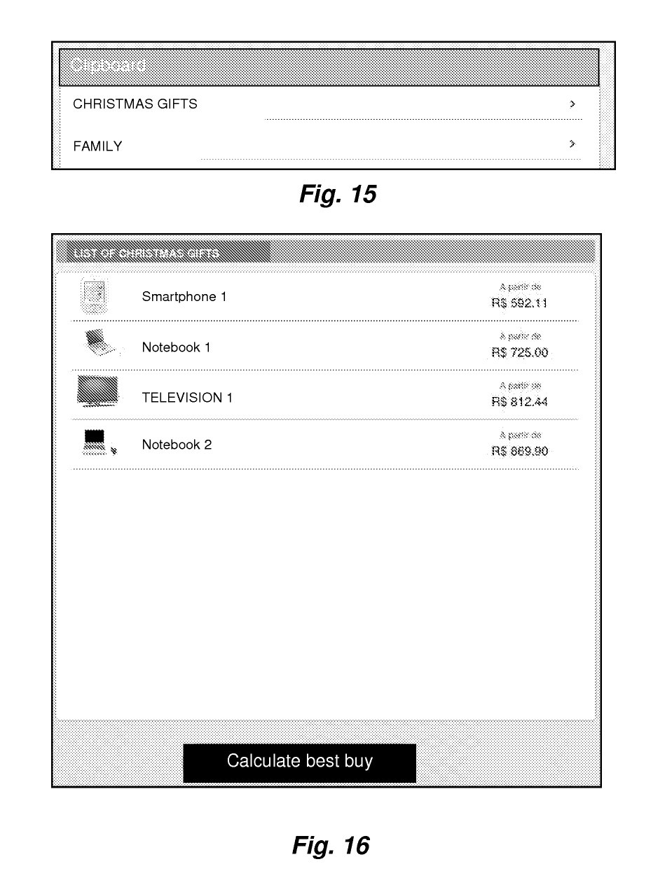

As can be seen in FIG. 14, the screen with the list of products can be accessed/viewed by clicking on the “clipboard” button located in the menu that appears to the left of the screen of the human interface device. This screen with the list of products also offers the edit function, enabling the removal or inclusion of one or more lists of products. Once the user has selected a certain list of products, the system and method of the invention are capable of retrieving the products contained in the list of products, as shown in FIGS. 15 and 16. In this example, the list of products “Christmas Gifts” (FIG. 15) was selected by the user, and FIG. 16 illustrates the content of the list of products “Christmas Gifts”, which comprises the products “Smartphone 1”, “Notebook 1”, “Television 1” and “Notebook 2”.

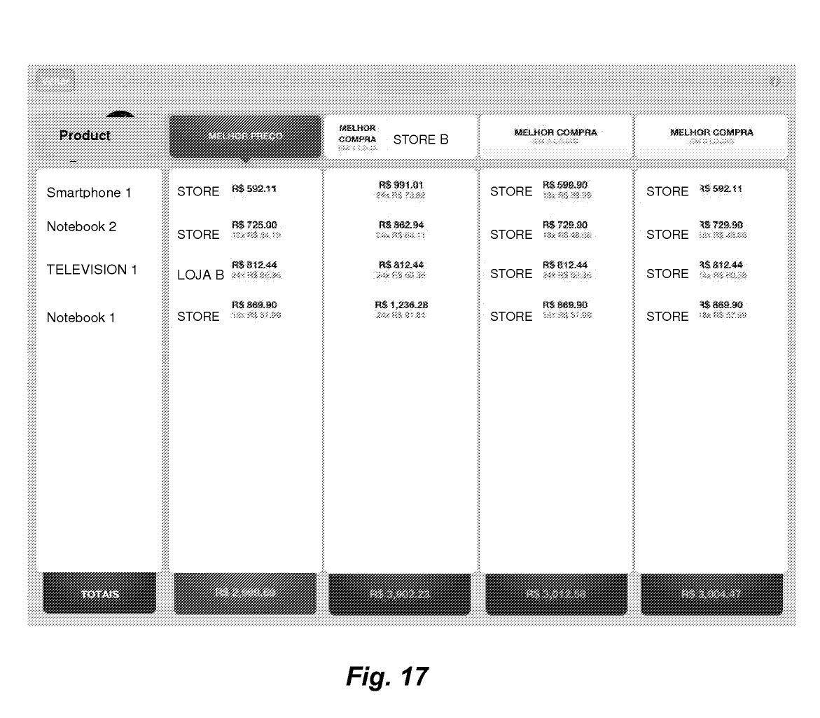

On the initial screen of the list of products, it is possible to remove one or more products from the list. Furthermore, as shown in FIG. 16, this screen allows access to the comparative table with the information on best price and lowest quantity of stores for the list of products specified, as can be seen in the screen illustrated in FIG. 17. Said access to the comparative table is made through the button “Calculate best buy” (FIG. 16). Lastly, and as described previously, the data is analyzed and treated so that it can be organized/arranged in the form of a comparative table, such as the one shown in FIG. 17.

Although the description of the particular embodiment above draws reference to one embodiment or particular example, the system and method of the present invention may be used for other types of applications and may bear modifications in their form of implementation, such that the scope of protection of the invention is limited solely by the content of the accompanying claims, including possible equivalent variations therein.

1. A system of organizing information on products available at virtual stores on the Internet, comprising at least:
a storage unit capable of storing information on the products and the virtual stores;
a human interface device capable of displaying the information on the products and the virtual stores;
a human control device capable of enabling an active interaction between a system user and the human interface device; and
a processing unit operatively associated to the human interface device, to the human control device and to the storage unit,
wherein the storage unit further comprises a virtual clipboard accessible by the user via the human interface device and the human control device, the virtual clipboard comprising at least one list of products,
a processing unit being arranged to enable the inclusion of at least one product in the list of products by means of the human interface device and the human control device,
a processing unit being arranged to list automatically the products included by the user in the list of products from virtual stores which provide said products.

2. A system, according to claim 1, wherein the processing unit is arranged to enable visualization and editing of the virtual clipboard and of the list of products by the user by means of the human interface device and the human control device.

3. A system, according to claim 2, wherein the processing unit is arranged to enable the inclusion and the removal of products in and from the list of products by the user by means of the human interface device and the human control device.

4. A system, according to claim 1, wherein the information stored in the storage unit on the virtual stores and the products consists of the names of the stores, of the names of the products, of the prices charged by the virtual stores for each product, of the payment terms offered at each store, of the unit freight value and of the total value of the purchase per store.

5. A system, according to claim 4, wherein the processing unit is arranged to arrange the information relating to the products contained in the list of products and to the virtual stores which provide said products in the form of a comparative table, the processing unit being further arranged to display the comparative table in the human interface medium.

6. A system, according to claim 5, wherein the comparative table is endowed with a sequence of columns, and at least one column comprises the prices of the products.

7. A system, according to the 6, wherein the comparative table is endowed with a first column which comprises the names of the products.

8. A system, according to the claim 7, wherein the comparative table is endowed with a second column which comprises the names of the virtual stores and the respective prices of the products charged by these virtual stores, and the sum of the prices of the products of the second column is minimal, regardless of the number of stores.

9. A system, according to claim 8, wherein the comparative table is endowed with a third column which comprises the prices of the products, and the sum of the prices of the products of the third column is minimal for a minimum number of stores.

10. A system, according to claim 9, wherein the comparative table is endowed with a fourth column which comprises the names of the virtual stores and the respective prices of the products, and the sum of the prices of the products of the third column is minimal for a minimum number of stores plus one.

11. A system, according to claim 10, wherein the comparative table is endowed with a fifth column which comprises the names of the virtual stores and the respective prices of the products, and the sum of the prices of the products of the fifth column is minimal for a minimum number of stores plus two.

12. A system, according to the claim 11, wherein the comparative table is endowed with a line of “totals” which comprises the sum of the prices of the products of each column.

13. A system, according to claim 1, wherein the virtual clipboard (5) comprises a plurality of lists of products.

14. A method of organizing information on products available at virtual stores on the Internet, comprising steps of:
i) preparing a list of products that a user wishes to acquire;
ii) searching for virtual stores which provide the products of the list prepared in step i;
iii) generating lists of prices of the products based on the virtual stores detected in step ii; and
iv) displaying to the user the lists of prices generated in step iii in the form of a comparative table endowed with a sequence of columns, and at least one column comprises the prices of the products.

15. A method, according to claim 14, wherein it additional comprises the step of v) storing the list of products prepared in step i and/or the stores detected in step ii.

16. A method, according to claim 14, wherein step iii comprises the following substeps:
iiia) calculating a total sum of the prices of the products of the list of products that is minimal, regardless of the number of stores;
iiib) calculating a total sum of the prices of the products of the list of products prepared in step i that is minimal, with a minimum number of stores;
iiic) checking whether the minimum number of stores relating to the substep iiib is less than the number of stores relating to the substep iiia;
iiid) should the verification of substep iiic prove positive, calculating a total sum of the prices of the products of the list of products that is minimal, with a minimum number of stores plus one;
iiie) checking whether the minimum number of stores plus one relating to the substep iiid is less than the number of stores relating to the substep iiia; and
iiif) should the verification of substep iiie prove positive, calculating a total sum of the prices of the products of the list of products that is minimal, with a minimum number of stores plus two.

17. A method, according to claim 16, wherein step iv comprises the substep of iva) arranging a first column which comprises the names of the products of the list of products prepared in step i.

18. A method, according to claim 17, wherein:
step iii comprises the substep of iiig) generating a first list of prices, and the total sum of the prices of the first list of prices is minimal, regardless of the number of stores; and
step iv comprises the substep of ivb) arranging a second column which comprises the first list of prices and the sum of the prices of the first list of prices.

19. A method, according to claim 18, wherein:
step iii comprises the substep of iiih) generating a second list of prices, and the sum of the prices of the second list of prices is minimal for a minimum number of stores; and
step iv comprises the substep of ivc) arranging a third column which comprises a second list of prices and the sum of the prices of the second list of prices.

20. A method, according to claim 19, wherein:
step iii comprises the substep of iiii) generating a third list of prices, and the sum of the prices of the third list of prices is minimal for a minimum number of stores plus one; and
step iv comprises the substep of ivd) arranging a fourth column which comprises a third list of prices and the sum of the prices of the third list of prices.

21. A method, according to claim 20, wherein:
step iii comprises the substep of iiij) generating a fourth list of prices, and the sum of the prices of the fourth list of prices is minimal for a minimum number of stores plus two; and
step iv comprises the substep of ive) arranging a fifth column which comprises a fourth list of prices and the sum of the prices of the fourth list of prices.

22. A method, according to claim 19, wherein if the number of stores of the second list of prices is different to one, step iv comprises the substep of ivf) informing the user in the third column that there is no single store tendering all the products of the list prepared in step i.

23. A method, according to claim 20, wherein if the number of stores of the third list of prices is no greater than one, step iv comprises the substep of ivg) informing the user in the fourth column that no information is available for the third list of prices.

24. A method, according to claim 21, wherein if the number of stores of the third list of prices is not less than the number of stores of the fourth list of prices, step iv comprises the substep of ivh) informing the user in the fifth column that no information is available for the fourth list of prices.

25. A method, according to claim 14, comprising a step of vi) editing the products from the list of products prepared in step i.

26. A method, according to claim 25, wherein step vi comprises the substep of via) removing at least one product from the list of products prepared in step i.

27. A method, according to claim 25, wherein step vi comprises the substep of vib) adding at least one product from the list of products prepared in step i.

28. A method, according to claim 14, comprising a step of vii) excluding the list of products prepared in step i.

29. A method, according to claim 14, comprising a step of viii) including a new list of products.
